(19) United States
(12) Patent Application Publication
(10) Pub. No.: US 2015/0104114 A1
(43) Pub. Date: Apr. 16, 2015

(54) METHOD OF PROCESSING PHOTOS FROM MULTIPLE SOURCES AND ITS APPARATUS

(71) Applicant: LANDSCAPE MOBILE, Beijing (CN)

(72) Inventors: Tian BAI, Beijing (CN); Yue ZHUGE, Beijing (CN); Wen-Liang XIAO, Beijing (CN); Peng QIN, Beijing (CN); Xiao-Bin ZHANG, Beijing (CN); Wei-Fan CHEN, Beijing (CN)

(73) Assignee: LANDSCAPE MOBILE

(21) Appl. No.: 14/514,016

(22) Filed: Oct. 14, 2014

(30) Foreign Application Priority Data
Oct. 14, 2013 (CN) 201310478916.3

(51) Int. Cl. G06T 5/50; G06F 17/30

(52) U.S. Cl. CPC G06T 5/50; G06F 17/3028; G06T 2207/20221
USPC 382/284

(57) ABSTRACT

The present invention relates to photo processing. Disclosed is a method for processing photos from multiple sources and its apparatus. In the present invention, the method of processing photos from multiple sources include: obtaining photo files from at least two sources; for the obtained photo files, merging the photo files originating from the same primitive photo into one photo object for post-processing in the unit of photo objects, each photo object contains pointer(s) to the photo file(s) corresponding with the photo object. In the present invention, while substantial contents of photo files from different sources are identical, the photo files are merged into one photo object, then users can operate in the unit of photo objects, a system automatically processes respective files of the photo objects according to different operation types, and users do not need to care about the detail of the level of the photo files, such as the sources of the photo files etc., which simplifies the user operations.

### RELATED APPLICATION

This application claims priority to and benefits of Chinese Patent Application Serial No. 201310478916.3, filed with the State Intellectual Property Office of P. R. China on Oct. 14, 2013. The entire content of the above-referenced application is incorporated herein by reference.

### FIELD

The present invention relates to photo processing, and more particularly relates to a method of processing photos from multiple sources and its apparatus.

### BACKGROUND

With the development of multi-media technology and network technology, places where massive photos reside include a variety of photo sources, such as local devices, remote devices, Internet services etc. Thus, users find that current photo applications have the following pain points:

Users have to go to various photo sources to view pieces of their life.

To see a specific photo, users have to remember where it resides and decide which application to use.

Users cannot view photos in an aggregated manner. For example, many third-party services encourage users to automatically upload photos from mobile devices, such that duplicate photos could be seen here and there.

Users cannot organize photos in an aggregated manner. For example, users cannot organize photos from multiple sources together into a semantic collection.

Users cannot share photos in an aggregated manner. Users cannot share photos from multiple sources in one batch with other users.

Users cannot operate on photos in an aggregated manner. For example, users cannot delete a photo at once from multiple sources.

It is difficult to share photos with friends due to people using different social network or different applications.

There are some existing mobile applications that collect photos from various sources into one place, but still into separate folders. This way, the photos are still separated by sources, so the above pain points are not addressed.

### BRIEF SUMMARY

The purpose of the present invention is to provide a method of processing photos from multiple sources and its apparatus, while substantial contents of photo files from different sources are identical, the photo files are merged into one photo object, then users can operate in the unit of photo objects, a system automatically processes respective files of the photo objects according to different operation types, and users do not need to care about the detail of the level of the photo files, such as the sources of the photo files etc., which simplifies the user operations.

To solve the above technical problems, one embodiment of the present invention discloses a method of processing photos from multiple sources, which includes the following steps:

obtaining photo files from at least two sources;

for the obtained photo files, merging the photo files originating from the same primitive photo into one photo object for post-processing in the unit of photo objects, each photo object containing pointer(s) to the photo file(s) corresponding with the photo object.

Another embodiment of the present invention also discloses an apparatus of processing photos from multiple sources, which comprises an obtaining module, a merging module, a post-processing module;

the obtaining module is used for obtaining photo files from at least two sources;

the merging module is used for merging the photo files originating from the same primitive photo into one photo object for the post-processing module to post-process in the unit of photo objects, each photo object containing pointer(s) to the photo file(s) corresponding with the photo object.

Comparing the embodiments of the present invention with prior arts, the main differences and their effects are:

While substantial contents of photo files from different sources are identical, the photo files are merged into one photo object, then users can operate in the unit of photo objects, a system automatically processes respective files of the photo objects according to different operation types, and users do not need to care about the detail of the level of the photo files, such as the sources of the photo files etc., which simplifies the user operations.

Further, by comparing fingerprints to determine whether the photo files originate from the same primitive photo, a high determining efficiency can be obtained.

Further, preliminarily grouping the photo files first before merging the photo files originating from the same primitive photo into one photo object helps to reduce computation needs.

Further, managing and sharing the event-based collections do not need to consider the different sources of the photo objects.

Further, in the step of merging photo files originating from the same primitive photo into one photo object, the mapping relationships between the photo object and the photo file(s) are built. Thus, when the photo object to be processed maps multiple photo files, the photo file(s) from the optimal source can be chosen according to the requirement for practical operation, so as to avoid unnecessary transfer steps and provide users best interactive experience.

Further, for viewing photos in full screen, a local device photo or a remote device photo is chosen instead of a local service photo or a third-party service photo, so that downloading is avoided when photos are viewed.

Further, for sharing a photo object to an event-based collection, a local service photo or a third-party service photo is chosen instead of a local device photo or a remote device photo, so that uploading is avoided.

Further, for posting a batch of photo objects to the network, a local service photo or a third-party service photo is chosen instead of a local device photo or a remote device photo, so that uploading is avoided.

Further, for deleting a photo object, all sources supporting the delete operation are selected to prompt the user for confirmation. Once the last photo file is deleted, the photo is no longer shown.

Further, multiple photo objects are organized into different types of collections according to attributes of the photo objects, so as to facilitate users to browse or search based on indexes.

### BRIEF DESCRIPTION OF THE DRAWINGS

FIG. 1 illustrates a flowchart of a method for processing photos from multiple sources, according to the first embodiment of the present invention.

FIG. 2 illustrates a flowchart of a method for processing photos from multiple sources, according to the third embodiment of the present invention.

FIG. 3 illustrates a flowchart of a method for processing photos from multiple sources, according to the third embodiment of the present invention.

FIG. 4 illustrates a block diagram of an apparatus for processing photos from multiple sources, according to the fourth embodiment of the present invention.

### DETAILED DESCRIPTION

In the following description, numerous technical details are provided for readers to better understand the application. However, it will be understood by one of ordinary skilled in the art that the technical solution claimed to be protected by those claims of this application can also be realized even without these technical details and not based on various changes and modifications of the following embodiments.

For the purpose, technical solution and merits of the present invention to be clearer, the following will further describe the embodiments of the present invention in detail with reference to the drawings.

In a word, design complications and technical challenges are presented mainly in the following two areas:

Aggregation: photos from multiple sources are matched, merged into a unified type of photo objects, and presented in a unified semantic view.

Organization: based on aggregation, the photos are organized into logical, meaningful and easy-to-use collections.

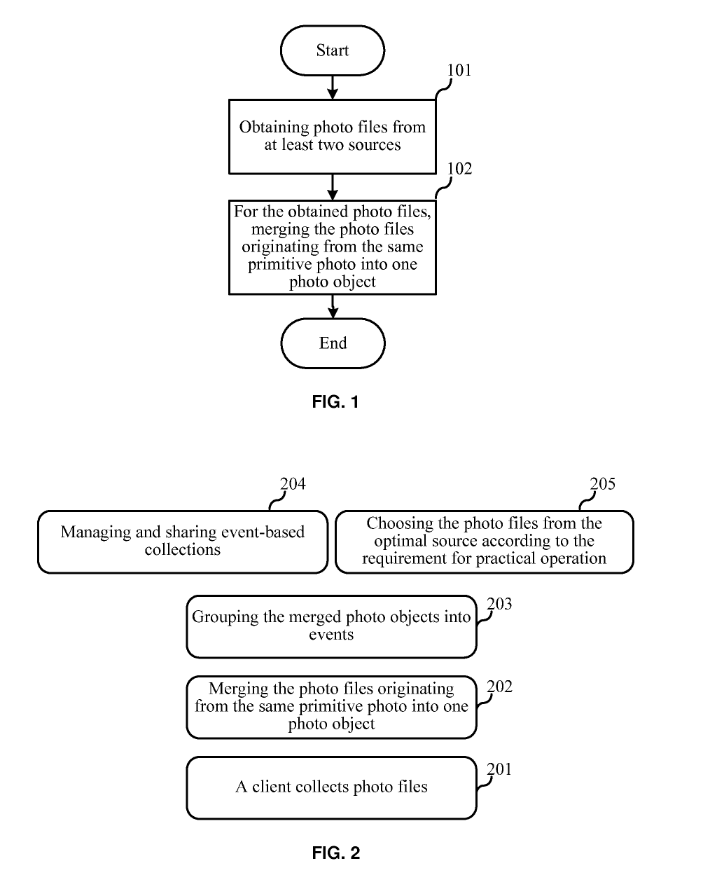

The first embodiment of the present invention relates to a method of processing photos from multiple sources. FIG. 1 illustrates a flowchart of the method of processing photos from multiple sources.

Specifically, as shown in FIG. 1, the method of processing photos from multiple sources includes the following steps:

In step 101, photo files are obtained from at least two sources.

It can be understood that in the present invention, “source” refers to where photos come from, usually in the form of a device or a service account.

Wherein, devices can be divided into local devices and remote devices. A local device refers to a computer or a mobile device that the user is utilizing with a client installed, and photos on a local device are called “local device photos”. A remote device refers to a computer or a mobile device that belongs to the user, other than the one being utilized, and photos on a remote device are called “remote device photos”. A client on a local device is “local client”, and a remote device is likely but not necessarily installed with a client, a client on a remote device being “remote client”. A remote device photo in full screen has been downloaded to a local device during this obtaining phase.

Service accounts can be divided into local service accounts and third-party service accounts. Photos on a local service account are called “local service photos”, which comprise photos uploaded from a client and photos shared from other users. Photos on a third-party service account are called “third-party service photos”, third-party services including Facebook, Dropbox, SkyDrive, Google Drive, Flickr, Web Album etc. Different accounts are different sources, for example, Dropbox account A and Dropbox account B are two different sources.

In the present invention, a client refers to photo processing applications on various mobile device or computer platforms. Systems include server programs and clients on various platforms.

Wherein, photo files are stored at the above four kinds of sources and can be read by a system, containing photos' contents.

Then proceeds to step 102, for the obtained photo files, the photo files originating from the same primitive photo are merged into one photo object for post-processing in the unit of photo objects. Wherein, each photo object contains pointer(s) to the photo file(s) corresponding with the photo object.

Preferably, the step 102 includes the following substeps:

whether the photo files originate from the same primitive photo is determined by comparing fingerprints;

the photo files originating from the same primitive photo are merged into one photo object.

Mapping relationships between the photo object and the photo file(s) are saved.

Wherein, a fingerprint is a small chunk of data calculated from a photo file to identify the photo file. It can be understood that by comparing fingerprints to determine whether the photo files originate from the same primitive photo in the present invention, a high determining efficiency can be obtained due to high abstract extent of photos' fingerprints. In the other embodiments of the present invention, whether the photo files originate from the same primitive photo can also be determined through a pixel-by-pixel comparison method or other methods.

In the substep of merging the photo files originating from the same primitive photo into one photo object, the merged photo object contains a thumbnail and a set of related attributes such as a timestamp and pointer(s) to corresponding photo file(s).

Preferably, the following steps are further included before the step 102:

the obtained photo files are preliminarily grouped, then the step 102 is performed on the grouped categories to merge the photo files originating from the same primitive photo into one photo object.

Preliminarily grouping the photo files first before merging the photo files originating from the same primitive photo into one photo object helps to reduce computation needs.

In addition, it can be understood that in other embodiments of the present invention, the step of preliminarily grouping the photo files may not be included.

Preferably, the following steps are further included after the step 102:

the photo objects are grouped into event-based collections for post-processing the photo objects in the unit of event-based collections. Preferably, the step includes the following substeps:

first, all photo objects are laid out into one timeline;

then the photo objects are grouped into corresponding event-based collections via an iterative process.

Wherein, the step of grouping the photo objects into corresponding event-based collections via an iterative process includes the following substeps:

candidate event-based collections are generated for the user's confirmation, each event-based collection respectively consisting of a group of photo objects;

the photo objects that have been confirmed by the user are excluded from an image pool;

the photo objects that do not belong to any event-based collection are sent back to the image pool, waiting for next grouping;

whether the number of the photo objects left is less than a predetermined value is determined, if it is, the photo objects left are grouped into miscellaneous collections. If not or new photo objects are inputted, then proceeds to next iterative process.

In addition, it can be understood that at the initial of the iterative process, all photo objects are not confirmed by the user, and the set of unconfirmed photo objects are called “image pool”.

Preferably, the step of generating candidate event-based collections uses an event detection algorithm, which utilizes one or any combination of the following attributes of photo objects:

metadata, photo object contents, existing organizations.

In the present invention, metadata attributes can comprise time and location, photo object contents attributes can comprise the number of people, indoor/outdoor and day/night, and existing organizations attributes can comprise folders, albums etc., but not limited thereto.

In the step of grouping the photo objects into event-based collections for post-processing the photo objects in the unit of event-based collections, the post-processing is managing and sharing the event-based collections.

Managing the event-based collections includes labeling the photo objects with an event-based collection name, and making comments on a group of or individual photo objects.

Sharing the event-based collections is sharing the event-based collection as a whole to other users.

Managing and sharing the event-based collections do not need to consider different sources of the photo objects.

The main advantage of this embodiment lies in: while substantial contents of photo files from different sources are identical, the photo files are merged into one photo object, then users can operate in the unit of photo objects, a system automatically processes respective files of the photo objects according to different operation types, and users do not need to care about the detail of the level of the photo files, such as the sources of the photo files etc., which simplifies the user operations.

The second embodiment of the present invention relates to a method of processing photos from multiple sources. The second embodiment improves the first embodiment, and the main improvements are described below.

The step 101 of obtaining photo files from at least two sources further includes the substep of constructing photo objects corresponding with each photo file;

Meanwhile, the step 102 of merging the photo files originating from the same primitive photo into one photo object for the obtained photo files is implemented by merging the photo objects which are constructed correspondingly with the photo files originating from the same primitive photo, into one photo object.

That is, the step of obtaining photo files includes two substeps of collecting photo files and constructing photo objects corresponding with the photo files in this embodiment.

In addition, it can be understood that the photo object constructed from one or multiple matched photo files contains the following data:

pointer(s) to the photo file(s) corresponding with the photo object and corresponding attributes, e.g. fingerprint(s), format, resolution etc., and visual images at different resolutions for different needs that are scaled/cropped from the photo files.

Preferably, according to different sources of the photo files, the step of constructing photo objects corresponding with each photo file includes the following substeps:

the photo object corresponding with local device photo file(s) is constructed by a local client;

when a remote device does not install a remote client, the photo object corresponding with remote device photo file(s) is constructed by a local client after the local client obtains the photo file(s); when the remote device installs a remote client, the corresponding photo object is constructed by the remote client, and the local client obtains the photo object directly;

the photo object corresponding with local service photo file(s) is constructed by a server;

the photo object corresponding with third-party service photo file(s) is constructed by a server with the user's permission.

The third embodiment of the present invention relates to a method of processing photos from multiple sources. The third embodiment improves the first embodiment, and the main improvements are described below.

The following steps are further included after the step 102 of merging the photo files originating from the same primitive photo into one photo object for the obtained photo files to post-process in the unit of photo objects:

When the photo object to be operated corresponds with multiple photo files from different sources, the client chooses the photo file(s) from the optimal source.

Specifically, for operation of previewing photo objects in full screen, the client chooses a local device or a remote device as the optimal source. For viewing photo objects in full screen, a local device photo or a remote device photo is chosen instead of a local service photo or a third-party service photo, so that downloading is avoided when photos are viewed. For a photo on the remote device, the photo in full screen has been downloaded to a local device during the obtaining phase and does not require a temporary download when it is viewed; whereas for a local service photo or a third-party service photo, the photo in full screen would not be downloaded during the obtaining phase, and requires a temporary download when it is viewed. Therefore, downloading is avoided when photos are viewed.

For operation of sharing a photo object to an event-based collection, the client chooses a local service account or a third-party service account as the optimal source. For sharing a photo object to an event-based collection, a local service photo or a third-party service photo is chosen instead of a local device photo or a remote device photo, so that uploading is avoided.

For operation of posting a batch of photo objects to the network, the client chooses a local service account or a third-party service account. For posting a batch of photo objects to the network, a local service photo or a third-party service photo is chosen instead of a local device photo or a remote device photo, so that uploading is avoided.

For operation of deleting a photo object, all sources supporting the delete operation are selected. For deleting a photo object, the user is prompted for confirmation. Once the last photo file is deleted, the photo object is no longer shown. In addition, it can be understood that users can deselect or select certain source.

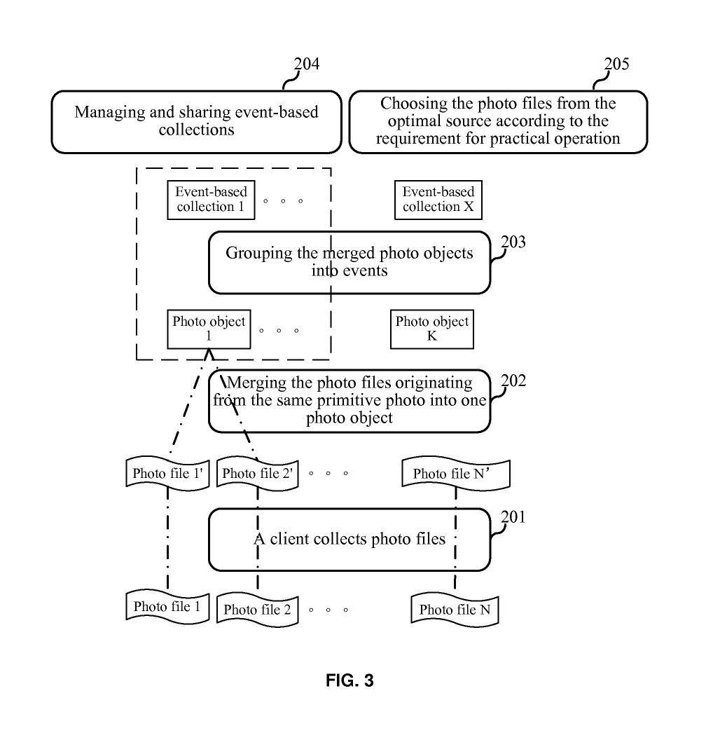

As a preferred example of the present invention shown in FIGS. 2, 3, FIGS. 2, 3 illustrate flowcharts of a method for processing photos from multiple sources. FIG. 3 further describes the processing objects for respective steps of the method for processing photos from multiple sources in detail based on FIG. 2.

Specifically, as shown in FIG. 2, in step 201, a client collects and prepares photo files to be processed.

Then proceeds to step 202, the photo files originating from the same primitive photo are merged into one photo object.

Photo files from different sources may correspond with same photo object, i.e. match with each other. The client performs the following two kinds of matching to determine whether the photo files correspond with same photo object, by comparing fingerprints:

Exact match: if two files are identical pixel by pixel, they are exact match.

Homologous match: if two files are not completely identical pixel by pixel, but by comparing one or multiple fingerprints, they are basically the same photo (probably resized), then they are homologous match. Homologous match may be false, so users are required to review and correct errors.

In addition, the mapping relationships between the photo object and its underlying photo file(s) are maintained. For further optimizations to reduce computation needs and offer better user experience, the step of merging the photo files into one photo object and the step of grouping the photo files are performed in an iterative manner. That is, the photo files can be grouped first before being merged into one photo object, such that only the photo files in the same category would be merged into one photo object, which significantly reduces computation needs.

After step 202, only one photo object is shown for a group of matched photo files.

Then proceeds to step 203, the merged photo objects are grouped into events.

First, the photo objects are laid out into one timeline, from the latest time to the earliest time.

Then the photo objects are grouped using an iterative method with the interaction of the users to obtain event-based collections.

Then proceeds to step 204 or step 205.

In step 204, the event-based collections are managed and shared.

Once photos are grouped into event-based collections, users can manage the photo objects, such as labeling the photo objects with an event-based collection name and making comments on a group of or individual photo objects. Users can also share the event-based collection as a whole to other users. And the above organization and sharing can be done regardless of different sources of the photo objects.

In step 205, the photo file(s) from the optimal source are chosen according to the requirement for practical operation. The operations can be applied to the photo objects seen by the user, and the execution of these operations is optimized.

In the step of aggregating photo files, the mapping relationships between the photo object and the photo file(s) are built. Thus, when operated photo object maps multiple photo files, the file(s) from the optimal source can be chosen according to the mapping relationships built before.

In addition, it can be understood that one or the combination of the step 204 of managing and sharing event-based collections and the step 205 of choosing the photo file(s) from the optimal source according to the requirement for practical operation can be selected to perform.

Preferably, the following step is further included after the step of merging the photo files originating from the same primitive photo into one photo object for post-processing in the unit of photo objects:

multiple photo objects are organized into different types of smart collections according to semantic attributes of the photo objects, the smart collections comprising collections by faces, collections by locations, collections by semantic tags, collections by qualities, collections by colors, collections by scenes, collections by landscapes or collections by portraits.

Wherein, the above semantic attributes are derived from the photo files, comprising attributes such as taken time, location, orientation, tags etc.

Preferably, the following step is further included after the step of merging the photo files originating from the same primitive photo into one photo object for the obtained photo files to post-process in the unit of photo objects:

indexes on the photo objects' semantic attributes are built for users to search through the photo objects.

The main advantage of this embodiment lies in: in the step of merging photo files originating from the same primitive photo into one photo object, the mapping relationships between the photo object and the photo file(s) are built. Thus, when the photo object to be processed maps multiple photo files, the photo file(s) from the optimal source can be chosen according to the requirement for practical operation, so as to avoid unnecessary transfer steps and provide users best interactive experience. Multiple photo objects are organized into different types of collections according to attributes of the photo objects, so as to facilitate users to browse or search based on indexes.

The method embodiments of the present invention all can be realized by software, hardware and firmware etc. Regardless of the present invention is realized by software, or hardware, or firmware, the instruction codes can be stored in any type of computer accessible memory (such as permanent or can be modified, volatile or non-volatile, solid-state or non solid, fixed or replaceable medium etc.). Similarly, the memory can be, for example, programmable array logic (PAL), random access memory (RAM), programmable read only memory (PROM), read-only memory (ROM), electrically erasable programmable ROM (EEPROM), floppy disc, optical disc, and digital versatile disc (DVD) etc.

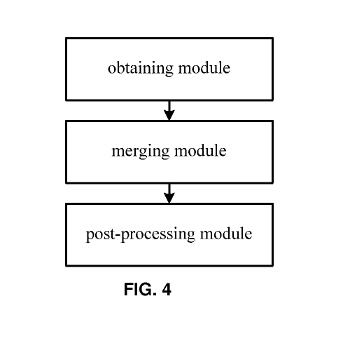

The fourth embodiment of the present invention relates to an apparatus of processing photos from multiple sources. FIG. 4 illustrates a block diagram of an apparatus for processing photos from multiple sources.

Specifically, as shown in FIG. 4, the apparatus of processing photos from multiple sources comprises an obtaining module, a merging module, a post-processing module.

The obtaining module is used for obtaining photo files from at least two sources.

The merging module is used for merging the photo files originating from the same primitive photo into one photo object for the post-processing module to post-process in the unit of photo objects, wherein, each photo object contains pointer(s) to the photo file(s) corresponding with the photo object.

Preferably, the merging module comprises the following submodules:

a determination submodule for determining whether the photo files originate from the same primitive photo by comparing fingerprints;

a merging core submodule for merging the photo files originating from the same primitive photo into one photo object;

a mapping submodule for saving mapping relationships between the photo object and the photo file(s).

Preferably, the apparatus of processing photos from multiple sources further comprises: a grouping module, an optimal source selection module, an organization module, a search module.

The grouping module is used for grouping the photo objects into event-based collections for post-processing the photo objects in the unit of event-based collections.

The optimal source selection module is used for choosing the photo file(s) from the optimal source to operate when the photo object to be operated corresponds with multiple photo files from different sources.

For operation of previewing photo objects in full screen, a local device or a remote device is chosen as the optimal source.

For operation of sharing a photo object to an event-based collection, a local service account or a third-party service account is chosen as the optimal source.

For operation of posting a batch of photo objects to the network, a local service account or a third-party service account is chosen as the optimal source.

For operation of deleting a photo object, all sources supporting the delete operation are chosen as the optimal sources.

The organization module is used for organizing multiple photo objects into different types of smart collections according to semantic attributes of the photo objects.

The search module is used for building indexes on the photo objects' semantic attributes for users to search through the photo objects.

The first, second, third embodiments are the method embodiments corresponding to this embodiment, and this embodiment and the first, second, third embodiments can be implemented in cooperation with each other. Correlated technical details disclosed in the first, second, third embodiments are still effective in this embodiment and will not be repeated here in order to reduce duplication. Correspondingly, correlated technical details disclosed in this embodiment can also be applied in the first, second, third embodiments.

The purpose of the present invention is to provide a method of processing photos from multiple sources and its apparatus. While substantial contents of photo files from different sources are identical, the photo files are merged into one photo object, then users can operate in the unit of photo objects, a system automatically processes respective files of the photo objects according to different operation types, and users do not need to care about the detail of the level of the photo files, such as the sources of the photo files etc., which simplifies the user operations.

The solution of the present invention is unique mainly in the following aspects:

The method for processing photos from multiple sources of the present invention allows multi-source photo alignment and processing possible. By following the above structure and algorithms, users can be provided with natural, unified photo viewing, management and sharing experience, independent of where the photos are stored.

By combining with the steps of the present invention, the design complications and technical challenges are conquered.

In particular, the merging step and the grouping step are performed in an iterative way. Merging photo files into photo objects depends on initial grouping, while grouping is performed on the merged photo objects.

Concept of virtual event-based collections is created and implemented which is unique due to the heterogeneous underlying data sources.

Optimal source selection also provides the best experience to the users.

It should be noted that units disclosed in each device embodiment of the present invention are logical units, on the physical, a logic unit can be a physical unit, and may be part of a physical unit, or implemented in combination with several physical units, and physical implementing methods for these logic units themselves are not the most important, the combination of the functions achieved by these logic units is the key to solving the technical problem disclosed in the present invention. Furthermore, in order to highlight innovative part of the present invention, the above device embodiments of the present invention do not introduce the units which are not related closely to solving the technical problem disclosed in the present invention, which does not indicate that the above device embodiments do not include other units.

It should be explained that in the Claims and Description of the present invention, relationship terms such as first, second etc are just utilized to distinguish one entity or manipulation from another entity or manipulation, instead of requiring or indicating any practical relation or sequence existing between these entities or manipulations. And, the terms “include”, “comprise” or any other variant indicate to nonexclusive covering, thus the process, method, article or equipment including a series of elements not only includes those elements, but also includes other elements which are not definitely listed, or inherent elements of this process, method, article or equipment. Without more limitations, the element defined by the phrase “include a” does not exclude additional same elements existing in the process, method, article or equipment of this element.

By referring to certain preferred embodiments of the present invention, the present invention has been shown and described. But it should be understood to those skilled in the art that various other changes in the forms and details may be made without departing from the principles and scope of the invention.

What is claimed is:

1. A method of processing photos from multiple sources, wherein the method includes the following steps:
obtaining photo files from at least two sources;
for the obtained photo files, merging the photo files originating from the same primitive photo into one photo object for post-processing in the unit of photo objects, each photo object containing pointer(s) to the photo file(s) corresponding with the photo object.

2. The method according to claim 1, wherein the method further includes the following steps:
grouping the photo objects into event-based collections for post-processing the photo objects in the unit of event-based collections.

3. The method according to claim 1, wherein the step of merging the photo files originating from the same primitive photo into one photo object for the obtained photo files further includes the following substeps:
determining whether the photo files originate from the same primitive photo by comparing fingerprints;
merging the photo files originating from the same primitive photo into one photo object;
saving mapping relationships between the photo object and the photo file(s).

4. The method according to claim 1, wherein the photo object further contains a thumbnail and attribute information.

5. The method according to claim 1, wherein the following steps are further included before the step of merging the photo files originating from the same primitive photo into one photo object for the obtained photo files:
preliminarily grouping the obtained photo files; and the step of merging the photo files originating from the same primitive photo into one photo object is performed on the grouped categories.

6. The method according to claim 2, wherein the step of grouping the photo objects into event-based collections includes the following substeps:
laying out all the photo objects into one timeline;
grouping the photo objects into corresponding event-based collections via an iterative process.

7. The method according to claim 6, wherein the step of grouping the photo objects into corresponding event-based collections via an iterative process uses an event detection algorithm, the event detection algorithm utilizes one or any combination of the following attributes of the photo objects:
metadata, photo object contents, existing organizations.

8. The method according to claim 2, wherein in the step of grouping the photo objects into event-based collections for post-processing the photo objects in the unit of event-based collections, the post-processing is managing and sharing the event-based collections.

9. The method according to claim 1, wherein the step of obtaining photo files from at least two sources further includes the substep of constructing photo objects corresponding with each photo file;
the step of merging the photo files originating from the same primitive photo into one photo object for the obtained photo files is implemented by merging the photo objects which are constructed correspondingly with the photo files originating from the same primitive photo, into one photo object.

10. The method according to claim 9, wherein the step of constructing photo objects corresponding with each photo file includes the following substeps:
constructing the photo object corresponding with local device photo file(s) by a local client;
when a remote device does not install a remote client, constructing the photo object corresponding with remote device photo file(s) by a local client after the local client obtains the remote device photo file(s); when the remote device installs a remote client, constructing corresponding photo object by a remote client, and directly obtaining the photo object by a local client;
constructing the photo object corresponding with local service photo file(s) by a server;
constructing the photo object corresponding with third-party service photo file(s) by a server with a user's permission.

11. The method according to claim 1, wherein the following steps are further included after the step of merging the photo files originating from the same primitive photo into one photo object for the obtained photo files to post-process in the unit of photo objects:
choosing the photo file(s) from the optimal source by a client when the photo object to be operated corresponds with multiple photo files from different sources.

12. The method according to claim 11, wherein in the step of choosing the photo file(s) from the optimal source by a client when the photo object to be operated corresponds with multiple photo files from different sources, the client chooses a local device or a remote device as the optimal source for operation of previewing photo objects in full screen.

13. The method according to claim 11, wherein in the step of choosing the photo files from the optimal source by a client when the photo object to be operated corresponds with multiple photo files from different sources, the client chooses a local service account or a third-party service account as the optimal source for operation of sharing a photo object to an event-based collection.

14. The method according to claim 11, wherein in the step of choosing the photo files from the optimal source by a client when the photo object to be operated corresponds with multiple photo files from different sources, the client chooses a local service account or a third-party service account as the optimal source for operation of posting a batch of photo objects to the network.

15. The method according to claim 11, wherein in the step of choosing the photo files from the optimal source by a client when the photo object to be operated corresponds with multiple photo files from different sources, all sources supporting the delete operation are selected to prompt a user to make confirmation for operation of deleting a photo object.

16. The method according to claim 1, wherein the following steps are further included after the step of merging the photo files originating from the same primitive photo into one photo object for post-processing in the unit of photo objects:
organizing multiple photo objects into different types of smart collections according to semantic attributes of the photo objects, the smart collections comprising collections by faces, collections by locations, collections by semantic tags, collections by qualities, collections by colors, collections by scenes, collections by landscapes or collections by portraits.

17. The method according to claim 1, wherein the following steps are further included after the step of merging the photo files originating from the same primitive photo into one photo object for the obtained photo files to post-process in the unit of photo objects:
building indexes on the photo objects' semantic attributes for users to search through the photo objects.

18. An apparatus of processing photos from multiple sources, wherein the apparatus comprises an obtaining module, a merging module, a post-processing module;
the obtaining module is used for obtaining photo files from at least two sources;
the merging module is used for merging the photo files originating from the same primitive photo into one photo object for the post-processing module to post-process in the unit of photo objects, each photo object containing pointer(s) to the photo file(s) corresponding with the photo object.

19. The apparatus according to claim 18, wherein the merging module comprises the following submodules:
a determination submodule for determining whether the photo files originate from the same primitive photo by comparing fingerprints;
a merging core submodule for merging the photo files originating from the same primitive photo into one photo object;
a mapping submodule for saving mapping relationships between the photo object and the photo file(s).

20. The apparatus according to claim 18, wherein the apparatus further comprises:
a grouping module for grouping the photo objects into event-based collections for post-processing the photo objects in the unit of event-based collections.

21. The apparatus according to claim 18, wherein the apparatus further comprises:
an optimal source selection module for choosing the photo file(s) from the optimal source to operate when the photo object to be operated corresponds with multiple photo files from different sources;
for operation of previewing photo objects in full screen, a local device or a remote device is chosen as the optimal source;
for operation of sharing a photo object to an event-based collection, a local service account or a third-party service account is chosen as the optimal source;
for operation of posting a batch of photo objects to the network, a local service account or a third-party service account is chosen as the optimal source;
for operation of deleting a photo object, all sources supporting the delete operation are chosen as the optimal sources.

22. The apparatus according to claim 18, wherein the apparatus further comprises:
an organization module for organizing multiple photo objects into different types of smart collections according to semantic attributes of the photo objects.

23. The apparatus according to claim 18, wherein the apparatus further comprises:
a search module for building indexes on the photo objects' semantic attributes for users to search through the photo objects.
